(19) United States
(12) Patent Application Publication
(10) Pub. No.: US 2002/0024445 A1
(43) Pub. Date: Feb. 28, 2002

(54) Flower container with water sensor and message reproducing device

(76) Inventors: Hideki Takayama, Kitasaku-Gun (JP); Tatsuo Takano, Kitasaku-Gun (JP)

Correspondence Address: ROTHWELL, FIGG, ERNST & MANBECK, P.C., 555 13TH STREET, N.W., SUITE 701, EAST TOWER, WASHINGTON, DC, 20004, US

(21) Appl. No.: 09/941,859

(22) Filed: Aug. 30, 2001

(30) Foreign Application Priority Data
Aug. 31, 2000 (JP) 2000-264270

(51) Int. Cl. G08B 21/00

(52) U.S. Cl. 340/603; 340/540

(57) ABSTRACT

A flower container has a control unit (14) comprising a water sensor (20) for directly or indirectly detecting water content in soil in a flowerpot (12), a memory (22) storing at least first and second recorded messages, and a speaker (32). When receiving a detection signal from the water sensor which indicates that the water content is decreased to below a predetermined level, the first message is read out from the memory and outputted through the speaker to urge a user to supply water. When the detection signal from the water sensor indicates that the water content is returned to above the predetermined level within a predetermined period of time from reproduction of the first message, the second message is read out from the memory and outputted through the speaker in appreciation of user's watering.

### BACKGROUND OF THE INVENTION

The present invention relates to a flower container such as flowerpot and planter having a water sensor.

Various flower containers with water sensor means have been proposed in Japanese patent publication (JP-A1) Nos. 8(1996)-140508, 7(1995)-115849, 8(1996)-280264, Japanese patent publication (JP-A2) No. 44(1969)-10950, Japanese utility-model publication (JP-A1) Nos. 7(1995)-24030, 1(1989)-82747, 51(1976)-33551, Japanese utility-model publication (JP-A2) No. 4-43011, Japanese utility-model registration No. 3049820, etc. In these prior arts, when the water sensor detects that water content in the soil is decreased to below a predetermined level, it generates a detection signal to a control unit which responsively produces a warning for urging the user to supply water into the container or drives an automatic watering device.

In accordance with the prior arts, a notice of water supply time (which comprises an alarming sound or light, for example) is given to the user in response to detection by the water sensor. This is really a machine-like solution. Even when the user supplies water in response to the alarm, the device shows no appreciation for his work. Automatic watering device is convenient but deprives the user of his pleasure of supplying water and raising the flower.

A potted plant is often shipped as a present to the sender's family or friend. The prior arts provide no friendly communication between the sender and the receiver.

### SUMMARY OF THE INVENTION

Accordingly, a principal object of the present invention is to provide a flower container capable of obviating the above-described drawbacks and disadvantages of the prior arts. More particularly, the object of the present invention is provide a flower container which not only produces a warning message for urging the user to supply water but also reproduce another message in appreciation of his watering.

To achieve these objects, according to an aspect of the present invention, there is provided a flower container comprising: (1) a flowerpot with an apertured bottom for accommodating soil and plant; (2) a water tray disposed below the apertured bottom of the flowerpot; (3) a control unit having: (i) a controller receiving; (ii) water sensor with electrodes projecting into the water tray; (iii) storage means storing at least first and second recorded messages, said first recorded message urging a user to supply water and said second recorded message appreciating user's watering; (iv) message reproducing means; (v) said controller being operative to read out said first message from said storage means and have said first message reproduced through said message reproducing means, when a detection signal from said water sensor represents that a water level in said water tray is below a predetermined level; and (vi) said controller being operative to read out said second message from said storage means and have said second message reproduced through said message reproducing means, when said detection signal from said water sensor represents that a water level in said water tray is returned to above said predetermined level within a predetermined period of time from reproduction of said first message through said message reproducing means; and (4) an outer pot receiving the flowerpot, the water tray and the control unit.

According to another aspect of the present invention, there is provided a flower container comprising: (1) a flowerpot with an apertured bottom for accommodating soil and plant; (2) water sensor for directly or indirectly detecting water content in soil in said flowerpot; (3) storage means storing at least first and second recorded messages, said first recorded message urging a user to supply water and said second recorded message appreciating user's watering; (4) message reproducing means; and (5) a controller receiving a detection signal from said water sensor, said controller being operative to read out said first message from said storage means and have said first message reproduced through said message reproducing means, when said detection signal from said water sensor represents that the water content is below a predetermined level, and said controller being operative to read out said second message from said storage means and have said second message reproduced through said message reproducing means, when said detection signal from said water sensor represents that the water content is returned to above said predetermined level within a predetermined period of time from reproduction of said first message through said message reproducing means. The water sensor may be provided with electrodes which projects into the soil through an apertured bottom of the flowerpot, which is a typical example of “direct” detection by the water sensor. Alternatively, the water sensor have electrodes projecting into a water tray or tank disposed separately or integrally with the flowerpot below an apertured bottom thereof, which is an example of “indirect” detection.

Another object of the present invention is to provide a message reproducing device for use with a flowerpot, which reproduces not only a first message for urging the user to supply water but also another message in appreciation of the user's watering in response to the first message.

To achieve this object, there is provided a message reproducing device for use in combination with and detachably fittable to a flowerpot comprising: (1) water sensor for directly or indirectly detecting water content in soil in the flowerpot when said device is fitted to the flowerpot; (2) storage means storing at least first and second recorded messages, said first recorded message urging a user to supply water and said second recorded message appreciating users watering; (3) message reproducing means; and (4) a controller receiving a detection signal from said water sensor, said controller being operative to read out said first message from said storage means and have said first message reproduced through said message reproducing means, when said detection signal from said water sensor represents that the water content is below a predetermined level, and said controller being operative to read out said second message from said storage means and have said second message reproduced through said message reproducing means, when said detection signal from said water sensor represents that the water content is returned to above said predetermined level within a predetermined period of time from reproduction of said first message through said message reproducing means.

Yet another object of the present invention is to provide a novel system and method by which a sender may send a product that is good for a present to the sender's family, friend, etc. in such a manner that any digital data chosen by the sender is in advance recorded in storage means of the product, which may be outputted through reproducing means of the product to notice a message from the sender to the receiver.

To achieve this object, there is provided a shipping data processing system for shipping a product with storage means for storing digital data and reproducing means for reproducing the digital data stored in said storage means, said shipping system being operated and controlled by an operation center, said operation center comprising: (1) means for acquiring order data necessary to identify at least a product to be shipped, an orderer of the product, an address of shipment, manner of payment and shipment, said order data being inputted by the orderer through a terminal data-communicable with said operation center; (2) means for storing the order data acquired by said order data acquiring means in combination with its inherent order number; (3) means for transmitting the order number to the terminal of the orderer; (4) means for acquiring digital data which is inputted by the orderer through operation of the terminal after the orderer receives the order number; and (5) data transfer means for transferring the digital data acquired by said digital data acquiring means to said storage means of the product to be shipped from the orderer to the address designated by said order data.

In accordance with another aspect, there is provided a shipping data processing method for shipping a product with storage means for storing digital data and reproducing means for reproducing the digital data stored in said storage means, said method being operated and controlled by an operation center, said method comprising the steps of: (1) acquiring order data necessary to identify at least a product to be shipped, an orderer of the product, an address of shipment, manner of payment and shipment, said order data being inputted by the orderer through a terminal data-communicable with said operation center; (2) storing the acquired order data in combination with its inherent order number; (3) transmitting the order number to the terminal of the orderer; (4) acquiring digital data which is inputted by the orderer through operation of the terminal after the orderer receives the order number; and (5) transferring the acquired digital data to said storage means of the product to be shipped from the orderer to the address designated by said order data.

### BRIEF DESCRIPTION OF THE DRAWINGS

Other objects and advantages of the present invention can be understood from the following description when read in conjunction with the accompanying drawings in which:

FIG. 1 is a vertical cross-section of a flower container embodying the present invention;

FIG. 2 is a block diagram of a control unit involved in the flower container of FIG. 1;

FIG. 3 shows a display panel arranged on a side wall of the flower container of FIG. 1;

FIG. 4 is a flowchart illustrating a control routine for water content detection and message reproduction which starts with turning-on of a power supply switch shown on the display panel of FIG. 3;

FIG. 5 is a flowchart illustrating another control routine for water content detection and message reproduction which starts with turning-on of a water content detection switch shown on the display panel of FIG. 3;

FIG. 6 is a vertical cross-section of a flower container according to another embodiment of the present invention;

FIG. 7 is a vertical cross-section of a flower container according to still another embodiment of the present invention;

FIG. 8 is a vertical cross-section of a flower container according to still another embodiment of the present invention;

FIG. 9 is a block diagram of a shipping data processing system embodying the present invention;

FIG. 10 is a flowchart illustrating data transmission between an operation center and a user's terminal to explain operation of the system of FIG. 9; and

FIG. 11 is a flowchart of a control routine for processing message data inputted by the user, which is a part of operation of the operation center of the system of FIG. 9.

### DETAILED DESCRIPTION OF THE PREFERRED EMBODIMENT

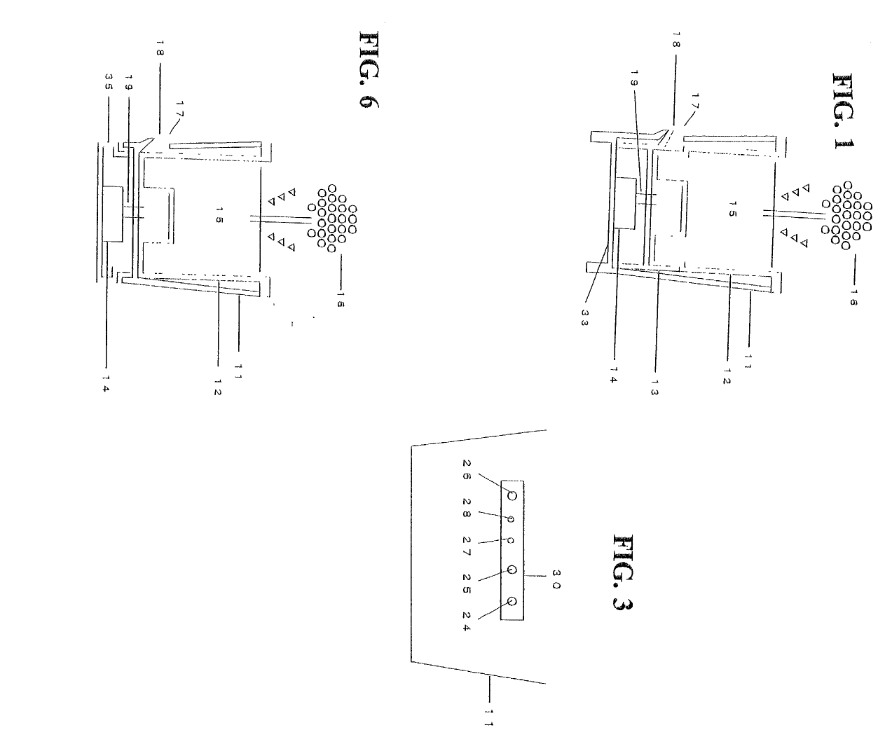

FIG. 1 is a vertical cross-section of a flower container 10 embodying the present invention. The flower container 10 has an outer pot 11, an inner pot or flowerpot 12, a water receiving tray 13 and a control unit 14. This flower container 10 is delivered to a purchaser or shipped to an address designated by an orderer or sender, with flowerpot 12 filled with soil 15 in which flower 16 is planted, which is referred to by a potted flower. A bottom of flowerpot 12 is apertured at least at a central elevated portion thereof. Water tray 13 is fitted to the bottom of flowerpot 12 to receive excessive water which may pass through the apertured bottom from the soil in flowerpot 12. A portion of water tray 13 is opened, which cooperates with an opening 17 of outer pot 11 to form a water supply port 18. Flowerpot 12 and water tray 13 are both detachably contained in outer pot 11.

Although control unit 14 is mounted or fixed on a bottom 33 of outer pot 11 which is spaced apart below water tray 13 in this embodiment, control unit 14 may be located at any desired position in any desired manner of attachment. In another embodiment, it is attached to the side wall of outer pot 11 by means of adhesive or screw means.

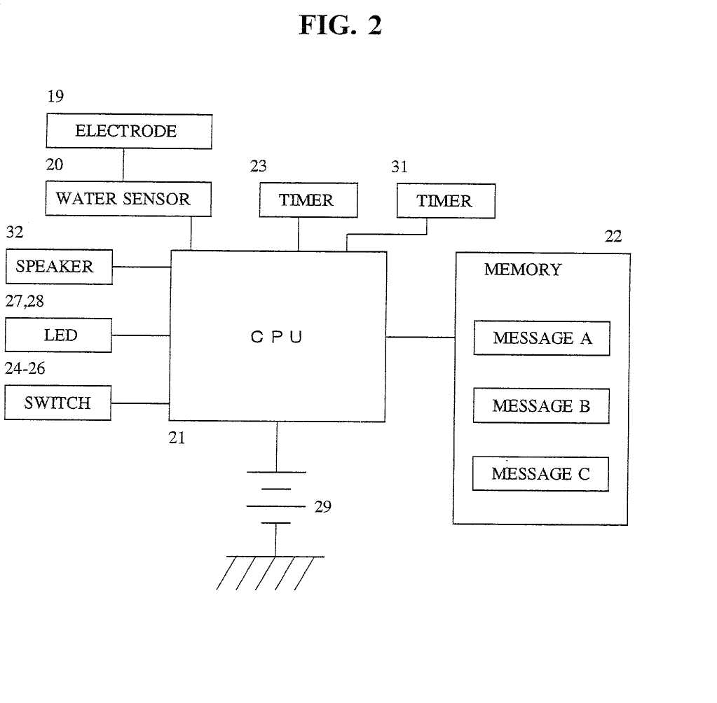

As shown in the block diagram of FIG. 2, control unit 14 has a water sensor 20 with electrodes 19 projecting upward through the bottom of water tray 13 into a central water receiving section thereof, a central-processing-unit (CPU) 21 driven by a power source 29 such as battery and alternate current, a memory 22 such as an IC tip connected to CPU 21, timers 23, 31, and a speaker 32 operating as message reproducing means. To CPU 21 are connected switches 24-26 and LED's 27, 28 to be described later.

Water sensor 20 detects water content in water tray 13. More specifically, when water content in water tray 13 is decreased to below a predetermined level to produce a closed circuit between electrodes 19, 19, it outputs a detection signal to CPU 21. Such water sensor is well known in the art and, therefore, no further description thereof is given herein.

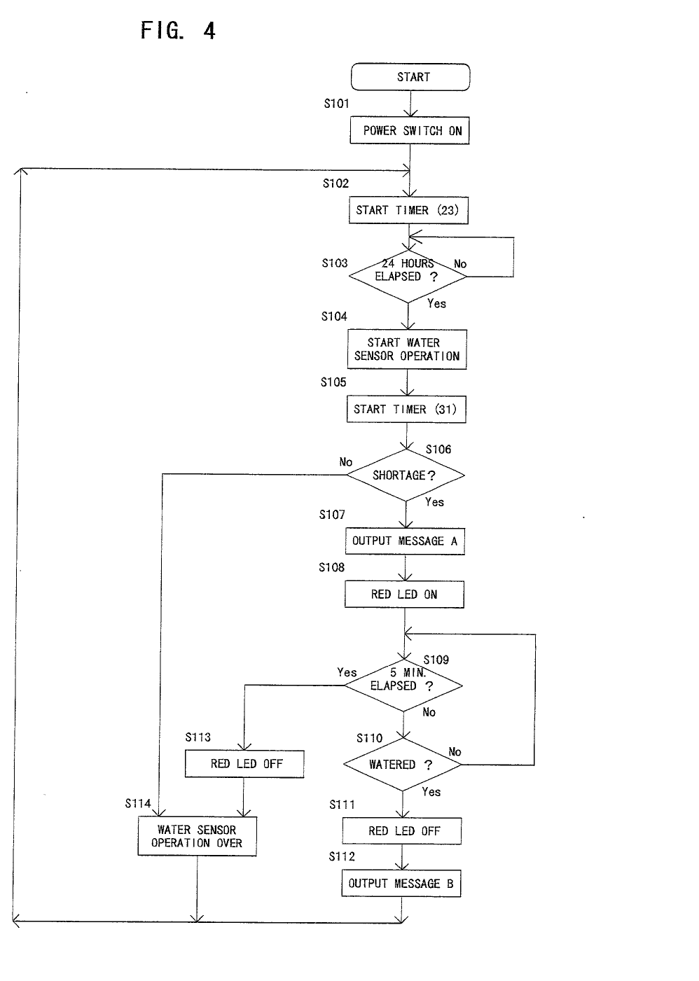

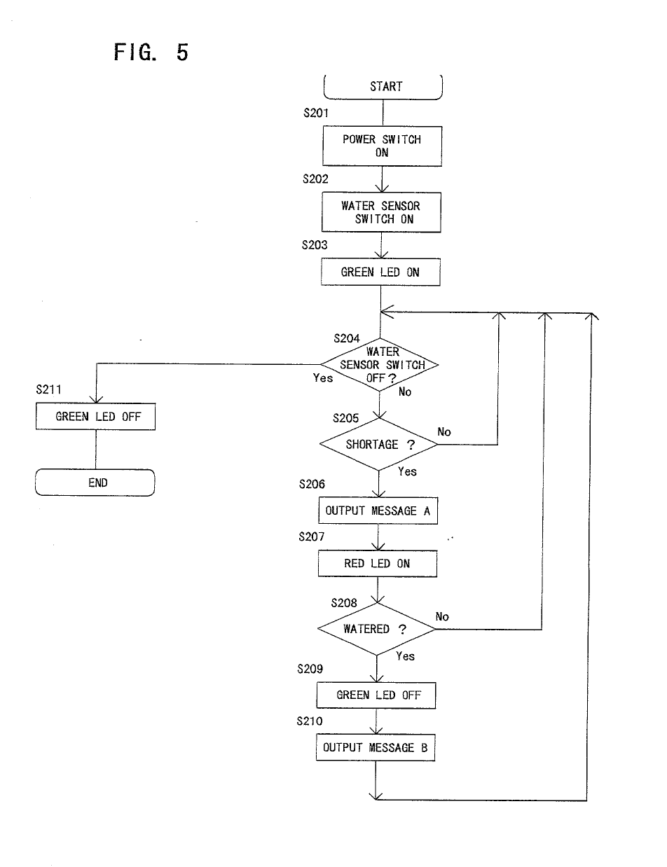

A display panel 30 is attached to the side wall of outer pot 11 at any desired position. As shown in FIG. 3, display panel 30 has a power supply switch 24, a water sensor switch 25 and a message reproducing switch 26. Power supply switch 24 is usually kept to be ON to drive CPU 21 for performing the control operation for water sensor detection and message reproduction, which will be described in reference to the flowcharts of FIGS. 4 and 5.

In this embodiment, as far as power supply switch 24 is ON, even if water sensor switch 25 is OFF, water sensor 20 will automatically detect water content in water tray 13 at a constant interval, say 24 hours, determined by timer 23. When the user wishes to confirm that the water content in water tray 13 is sufficient, he may push switch 25 at any time to activate water sensor 20.

In this embodiment, three different messages are in advance stored in memory 22, one of which is selected in response to detection by water sensor 20 or in response to the user's operation of message reproducing switch 26 to be reproduced through speaker 32. More specifically, a first message A stored in memory 22 is a message for urging the user to supply water to water tray 13 through port 18 when sensor 20 detects a shortage of water content in tray 13. An example of message A is a voice message saying “Water, please!”. A second message B is outputted when detecting that watering is carried out by the user in response to reproduction of message A within a predetermined period of time, say 5 minutes, set by timer 31. Such detection is confirmed when sensor 20 detects that water content in tray 13 is returned to the predetermined level after detecting the shortage of water content. An example of message B is a voice message saying “Thank you for watering !”. Reproduction of message A and/or B may be repeated several times. A third message C is outputted when switch 26 is turned on, an example of which is a voice message saying “Happy birthday !”.

Display panel 29 also has LED 27 and LED 28. LED 27 is turned on in response detection of the shortage of water content in tray 13 and lightened for five minutes, which also urges the user to supply water. When watering is made within the five minutes interval, LED 27 is turned off to be put out. LED 28 is turned on in response to turning-on of switch 25 and turned off when sensor 20 detects a sufficient water content in tray 13. When sensor 20 detects the shortage of water content in tray 13, LED 28 is turned off once sensor 20 detects that water content is returned to above the predetermined level or after elapse of five minutes while detecting no water supply.

FIG. 4 is a flowchart illustrating a control routine for detection of water content and reproduction of messages A and B, which starts with turning-on of power supply switch 24 shown on display panel 20. In the flowcharts of FIGS. 4 and 5, LED 27 emits a red-colored light and LED 28 emits a green-colored light.

When power supply switch 24 is turned on to energize control unit (Yes at S101), CPU 21 starts timer 23 (S102). After 24 hours (Yes at S103) which is detected by timer 23, CPU 21 starts water sensor 20 (S104) and timer 31(S105). When sensor 20 detects the shortage of water content in tray 13 (Yes at S106), CPU 21 reads message A (“Water, please !”) from memory 22 to be reproduced through speaker 32 (S107) and lighten red LED 27 (S108) for urging the user to supply water into tray 13. When no watering is made within a five-minute period (No at S110), which is detected by timer 31 (Yes at S109), red LED 27 is turned off (S113). In this case, water content detection procedure is completed (S114) and returned to S102 to reset timer 23. When watering is made within the five-minutes period (Yes at S110), CPU 21 turns red LED 27 off (S111) and reads out message B (“Thank you for watering !”) from memory 22 to be reproduced through speaker 32 (S112). The procedure is returned to S102 to reset timer 23.

FIG. 5 is a flowchart illustrating another control routine for detection of water content and reproduction of messages A and B, which starts with turning-on of water content detection switch 25 shown on display panel 20. When water content detection switch 25 is turned on (S201), CPU 21 readily starts water sensor 20 to carry out its water content detection operation (S202) and lighten green LED 28 (S203). If water content detection switch 25 is again depressed to be turned off (Yes at S204) at this time, green LED 28 is turned off (S211) and this control routine has been completed.

When water sensor 20 detects the shortage of water content in tray 13 (S205) with the status of switch 25 being kept to be ON (No at S204), CPU 21 reads message A (“Water, please !”) from memory 22 to be reproduced through speaker 32 (S206) and lighten red LED 27 (S207) for urging the user to supply water into tray 13. When watering is made by the user in response to reproduction of message A and lightening of red LED 27 (Yes at S208), which is discriminated by sensor 20 detecting that the water content in tray 13 is returned to above the predetermined level, CPU 21 turns red LED 27 off (S209) and reads out message B (“Thank you for watering !”) from memory 22 to be reproduced through speaker 32 (S210). The procedure is then returned to S204. When, on the other hand, no watering is made (No at S208), which is discriminated by sensor 20 still detecting the shortage of water content, the procedure is returned to S204. Even when the status of switch 25 is kept to be ON (No at S204), as far as the water content in tray 13 is sufficient (No at S205), the procedure from S206 onwards is not carried out and CPU 21 awaits turning-off of switch 25 (Yes at S204).

Although a specific design of the flower container is shown in FIG. 1, this may be modified as shown in FIG. 6 in which no separate water tray 13 is used. In this embodiment, outer pot 11 serves as a water tray or tank. Electrodes 19 of sensor 20 project into the interior of outer pot 11 through apertures thereof, to thereby detect water content in outer pot 11.

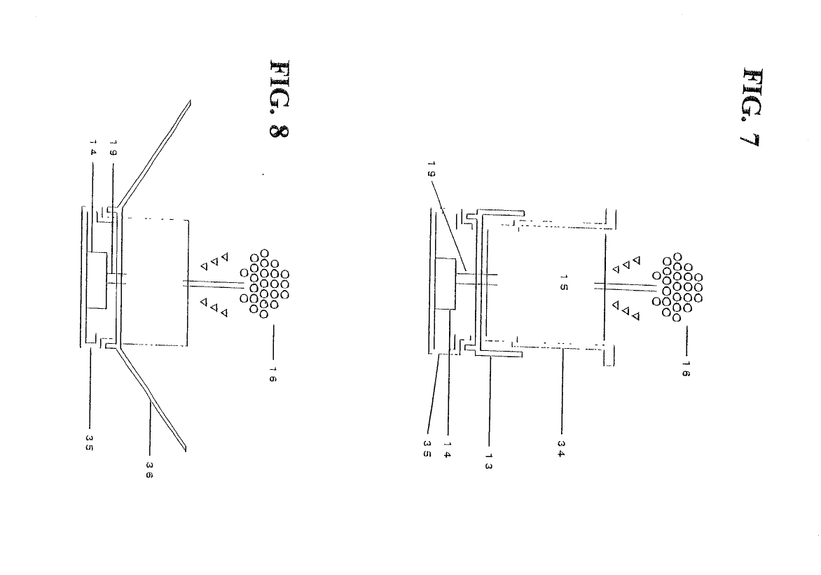

Another modification is shown in FIG. 7 wherein a single pot or container 34 is supported on the bottom of a separate water tray 13. Electrodes 19 of sensor 20 project into the interior of pot 34 through apertured bottoms of water tray 13 and pot 34 to detect water content in pot 34. In still another modification shown in FIG. 8 which may be referred to as a flower arrangement, electrodes 19 of sensor 14 projects into sponge material (not indexed) on a flower vase 36 through apertured bottom thereof.

In the embodiments shown in FIGS. 6-8, controller 14 is contained in a separate unit 35 which may be used as a mount for supporting thereon outer pot 11 (FIG. 6), water tray 13 (FIG. 7) and flower vase 36 (FIG. 8). Such arrangement is compared with the embodiment of FIG. 1 wherein controller 14 is beforehand incorporated in the overall flower container. Accordingly, the embodiment of FIG. 1 will be suitable to sale of a potted flower with controller 14 incorporated therein, whereas the embodiments of FIGS. 6-8 will be suitable to sale of control unit 35 to be attached to an existing pot or vase that the user already possesses for adding function of water content detection and message reproduction.

The messages A, B and C in the foregoing description are only examples and may be modified as desired. Each of these messages may comprise synthesized voice data or voice data which is digitalized from natural voice of the user or sender of the potted flower or control unit 35. By way of example wherein someone wishes to ship a potted flower such as shown in FIG. 1 to his family living in a remote place or his friend or lover, he may desire that his natural voice is recorded as at least one of messages A-C so as to convey his friendly feeling to the receiver.

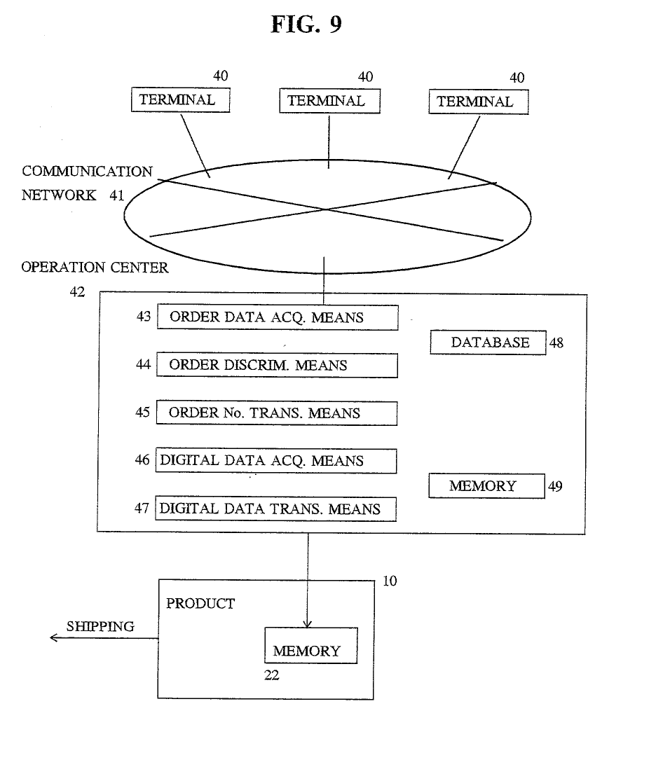

FIG. 9 is a block diagram of a shipping data processing system capable of shipping a product such as a potted flower with digital data being recorded by a sender to be given to a receiver. The product to be shipped in this system is not limited to a potted flower but should be equipped with a memory for storing digital data and a speaker or other means for reproducing the digital data stored in the memory. The digital data is voice data in the following description, but may comprise image data captured from a photograph of the sender's face, for example.

This system comprises a plurality of users' terminals 40, 40, 40 . . . to be operated by respective orderers, an operation center 42 and a communication network 41 such as the Internet for bidirectional data communication between the respective terminals 40 and the operation center 42. Each terminal 40 may comprise a computer system including an input device, a display, storage means, a communication control unit, etc. as well known in the art.

The operation center 42 is equipped with order data acquisition means 43 for acquiring order data necessary to identify at least a product to be shipped, an orderer of the product, an address of shipment, manner of payment and shipment. The order data is inputted by the orderer through his terminal 40. The operation center 42 also has order discrimination means 44 for collating the order data with database 48 such as inventory control database and shipment control database to discriminate if the order data is acceptable or not. The operation center 42 also includes a memory 49 for storage of the order data acquired by means 43 in combination with its order number inherent thereto, and order number transmission means 45 for transmitting the order number to the terminal 40 of the orderer.

The operation center 42 further comprises digital data acquisition means 46 for acquiring digital data inputted by the orderer through operation of the terminal after the orderer receives the order number, and digital data transfer means 47 for transferring the digital data acquired by the acquisition means 46 to memory 22 (FIG. 1) of the product (a potted flower) to be shipped from the orderer to the address designated by the order data.

The operation center 42 prepares a homepage on the Internet, which includes, for example, a main page showing the system profile and a plurality of sub-pages including a catalog page showing a list of products which may be ordered via the Internet, an order page showing an order form to be filled out when ordering some of the products shown on the catalog page, and a message entry page describing a manner of how to operate the orderer's terminal 1 when the orderer wishes to incorporate some voice message to the shipped product. When some product is to be ordered, an orderer makes access to the order page to input the order data by operation of his terminal 40. The order data includes, for example, a brand name or any other data necessary to identify the product to be ordered, the number of the product, the orderer's name, address, postal code, telephone number, facsimile number, e-mail address, etc, an address of shipment or a receiver's name, address, postal code, telephone number, etc., manner of payment (by credit card, debit card, bank transfer, cash-on-delivery, etc.) that the orderer wish in purchasing the product, and manner of shipment (date and time of arrival that the orderer designate). These items may be inputted on different order pages.

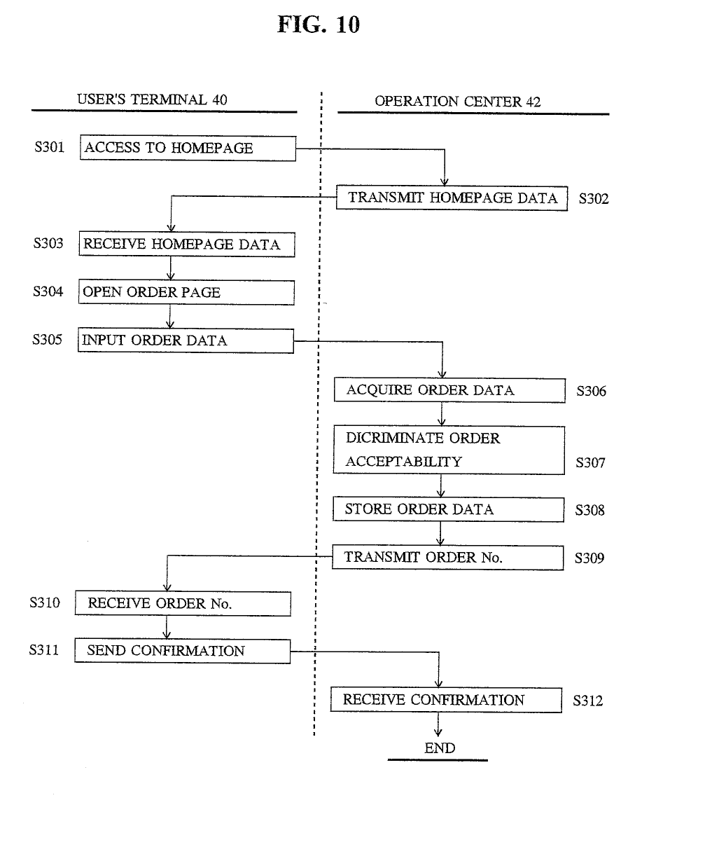

Reference should now be made to the flowchart of FIG. 10. When the orderer makes access to the homepage of the operation center 42 via a WWW browser or viewer software installed in his terminal 40 (Yes at S301), the center 42 transmits data to the orderer's terminal 40 through the Internet 41 (S302), by which pictures of the homepage may be displayed on a display connected to the terminal 40. After receiving the homepage viewing data (S303), the orderer opens the order page (S304) on which necessary order data are inputted by operation of his terminal 40 (S305).

When the order data acquisition means 43 acquires the inputted order data (S306), the center 42 makes the order discrimination means 43 to discriminates if the order specified by the acquired order data is acceptable or not by collating the order data with database 48 such as inventory control database and shipment control database (S307). If the order is found acceptable, the order data is stored in the memory 49 together with its inherent order number (S308). Although not shown, if the order is not acceptable, the center 42 transmits an error message such as “Sorry, no stock at present.”, “Sorry, your credit card is not acceptable”, “Sorry, the ordered product can not arrive at the receiver's address at your designated date and time.”, for example, to the orderer's terminal 40 for urging re-input of the order data or cancellation of order.

When the order data is stored in the memory 49 together with its inherent order number (S308), the center 42 makes the transmission means 45 to transmit an order confirmation message to the orderer's terminal 40 (S309). The order confirmation message may be one saying “Thank you for your order. Your order is #123456.”, for example. The orderer receives-this message (S310) to confirm that the order data inputted at S305 is accepted with no problem by the center 42, and send an order confirmation to the center 42 (S311). When the center 42 receives the confirmation from the orderer (S312), the order data processing operation has been completed.

When the orderer wishes to incorporate his voice message to the product to be shipped, such voice message data is inputted together with the order data at S305. The voice message data may be recorded in a data file accompanying the order data so that center 42 receives the order data and the voice message data at S306. In this embodiment, the order data acquisition means 43 also functions as the digital data acquisition means 46.

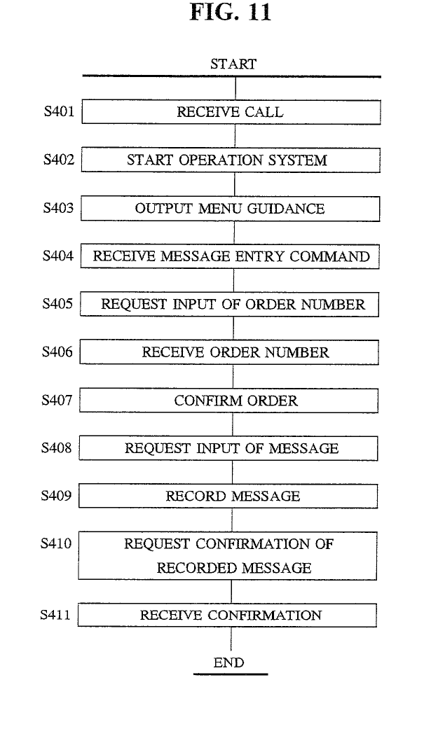

In an alternate embodiment, after the order data processing operation has been completed, the orderer may call the center 42 to transmit his desired voice message via a telecommunication line. In this embodiment, the digital data acquisition means 46 in the center 42 comprises an automatic telephone operation system which executes the voice message processing operation in accordance with the flowchart of FIG. 11. More specifically, when receiving a telephone call from an orderer (S401), the automatic telephone operation system starts (S402) to automatically output a menu guidance (S403). The menu guidance may be, for example, “Thank you for your call. This is ∘ ∘ operation center. When you wish to incorporate your voice message into a product you have already ordered, please push No. 1 button. When you wish to place a new order, push No. 2 button. Push No. 3 button when you have any question”. When confirming that the No. 1 button is pushed (S404), the system automatically outputs a message which urges the orderer to input the order number of shipment of the product (S405). Such a message may be “Please input your order number”. The system receives the order number (S406) and confirms that such order has truly been accepted by collation of the received order number with data stored in memory 49 (S407). Then, the system automatically outputs another message which urges the orderer to input his desired voice message to be incorporated to the ordered product (S408). Such a message may be “Your message is recorded in ten seconds. Speak your message after a beep”. The inputted voice message is transferred to digital data which is stored in a voice message memory (not shown in FIG. 9) in the automatic telephone operation system (S409). After elapse of the ten-second recordable period, the system automatically outputs the recorded voice message and a confirmation requesting message to the orderer (S410), which may be “This is the message you have recorded. Push No. 1 button when this is really you want. Push No. 2 button if you need correction”. When the orderer pushes No. 2 button in response to such a message to send a message confirmation signal, it is received by the system (S411) and the voice message processing operation has been completed.

As above described, the voice message data is acquired together with the order data at S305 of the flowchart of FIG. 10 and recorded in memory 49 in the operation center 42, or alternatively recorded in the voice message memory in the automatic telephone operation system at S409 of the flowchart of FIG. 9. In either case, the voice message data is transferred to memory 22 of the ordered product (potted flower) as at least one of the messages A-C. For example, the voice message data recorded in memory 49 or in the voice message memory in the automatic telephone operation system is transferred to a working memory, which is collated with the order data in memory 49 to find a specific order. The control unit 14 of the potted flower, that is the ordered product, is connected to the computer system in the operation center 42 so that the voice message data in the working memory is further transferred to memory 22 (see FIG. 2).

Although the present invention has been described in conjunction with specific embodiments thereof, it is to be understood that many modifications and variations may be made without departing from spirits and scopes of the present invention as defined in the appended claims. A product with the sender's natural voice message may be shipped to any address where the sender designate, which may be the sender's own home or office. The voice message to be incorporated to a product is not limited to the sender's natural voice message. Another example of the voice data is yelping or crying of animal such as puppies and kitties, which may be recorded typically as the message C. The sender's natural voice message may be combined with such animal voice to prepare the voice data to be incorporated to the product.

In place of the voice data or in combination with the voice data, the image data may also be incorporated to the product. An example of the image data is taken by a digital camera. In this embodiment, the product has a display as means for representing the image data. The image data may be recorded in a data file accompanying the order data at S305 (FIG. 10), which will be received at the same time by the center 42 at S306.

What is claimed is:

1 A flower container comprising:
(1) a flowerpot with an apertured bottom for accommodating soil and plant;
(2) a water tray disposed below the apertured bottom of the flowerpot;
(3) a control unit having:
(i) a controller;
(ii) a water sensor with electrodes projecting into the water tray;
(iii) storage means storing at least first and second recorded messages, said first recorded message urging a user to supply water and said second recorded message appreciating user's watering;
(iv) message reproducing means;
(v) said controller being operative to read out said first message from said storage means and have said first message reproduced through said message reproducing means, when a detection signal from said water sensor represents that a water level in said water tray is below a predetermined level; and
(vi) said controller being operative to read out said second message from said storage means and have said second message reproduced through said message reproducing means, when said detection signal from said water sensor represents that a water level in said water tray is returned to above said predetermined level within a predetermined period of time from reproduction of said first message through said message reproducing means; and
(4) an outer pot receiving the flowerpot, the water tray and the control unit.

2 A flower container comprising:
(1) a flowerpot with an apertured bottom for accommodating soil and plant;
(2) water sensor for directly or indirectly detecting water content in the soil in said flowerpot;
(3) storage means storing at least first and second recorded messages, said first recorded message urging a user to supply water and said second recorded message appreciating user's watering;
(4) message reproducing means; and
(5) a controller receiving a detection signal from said water sensor, said controller being operative to read out said first message from said storage means and have said first message reproduced through said message reproducing means, when said detection signal from said water sensor represents that the water content is below a predetermined level, and said controller being operative to read out said second message from said storage means and have said second message reproduced through said message reproducing means, when said detection signal from said water sensor represents that the water content is returned to above said predetermined level within a predetermined period of time from reproduction of said first message through said message reproducing means.

3 A message reproducing device for use in combination with and detachably fittable to a flowerpot comprising:
(1) water sensor for directly or indirectly detecting water content in soil in the flowerpot when said device is fitted to the flowerpot;
(2) storage means storing at least first and second recorded messages, said first recorded message urging a user to supply water and said second recorded message appreciating user's watering;
(3) message reproducing means; and
(4) a controller receiving a detection signal from said water sensor, said controller being operative to read out said first message from said storage means and have said first message reproduced through said message reproducing means, when said detection signal from said water sensor represents that the water content is below a predetermined level, and said controller being operative to read out said second message from said storage means and have said second message reproduced through said message reproducing means, when said detection signal from said water sensor represents that the water content is returned to above said predetermined level within a predetermined period of time from reproduction of said first message through said message reproducing means.

4 A shipping data processing system for shipping a product with storage means for storing digital data and reproducing means for reproducing the digital data stored in said storage means,
said shipping system being operated and controlled by an operation center, said operation center comprising:
(1) means for acquiring order data necessary to identify at least a product to be shipped, an orderer of the product, an address of shipment, manner of payment and shipment, said order data being inputted by the orderer through a terminal data-communicable with said operation center;
(2) means for storing the order data acquired by said order data acquiring means in combination with its inherent order number;
(3) means for transmitting the order number to the terminal of the orderer,
(4) means for acquiring digital data which is inputted by the orderer through operation of the terminal after the orderer receives the order number, and
(5) data transfer means for transferring the digital data acquired by said digital data acquiring means to said storage means of the product to be shipped from the orderer to the address designated by said order data.

5. A shipping data processing method for shipping a product with storage means for storing digital data and reproducing means for reproducing the digital data stored in said storage means, said method being operated and controlled by an operation center,
said method comprising the steps of:
(1) acquiring order data necessary to identify at least a product to be shipped, an orderer of the product, an address of shipment, manner of payment and shipment, said order data being inputted by the orderer through a terminal data-communicable with said operation center;
(2) storing the acquired order data in combination with its inherent order number;
(3) transmitting the order number to the terminal of the orderer,
(4) acquiring digital data which is inputted by the orderer through operation of the terminal after the orderer receives the order number; and
(5) transferring the acquired digital data to said storage means of the product to be shipped from the orderer to the address designated by said order data.
